(19) United States
(12) Patent Application Publication
(10) Pub. No.: US 2026/0260006 A1
(43) Pub. Date: Sep. 3, 2026

(54) UTILIZATION OF DETACHED POINTERS WITH MICROSHARD DATA FRAGMENTATION

(71) Applicant: Shardsecure, Inc., New York, NY (US)

(72) Inventors: Christer ROSLUND, Tyreso (SE); Jesper TOHMO, Varmdo (SE); Anthony WHITEHEAD, Njurunda (SE); Louis A. STEINBERG, Yorktown Heights, NY (US)

(21) Appl. No.: 18/994,706

(22) PCT Filed: Jul. 14, 2023
(86) PCT No.: PCT/US2023/027702

§ 371 Date: Jan. 15, 2025

Related U.S. Application Data
(60) Provisional application No. 63/394,780, filed on Aug. 3, 2022.

(51) Int. Cl. G06F 21/62

(52) U.S. Cl. CPC G06F 21/6218

(57) ABSTRACT

The utilization of detached pointers as part of microshard data fragmentation is described. A method includes receiving a request from an owner of a source file to break the source file into a set of microshard data fragments and store the set of microshard fragments, processing the source file to generate the microshard data fragments and store the microshard data fragments in a plurality of storage resources, generating authentication information linking the owner of the source file to the stored microshard data fragments, generating a pointer file identifying the locations on the storage resources where each microshard data fragment is stored, and providing the pointer file to the owner of the source file without retaining a copy of the pointer file along with at least a portion of the authentication information. The authentication information allows the owner to request future access to the set of microshard data fragments.

### TECHNICAL FIELD

The present disclosure generally relates to secure storage and retrieval of data and, more particularly, to the use of detached pointers as part of storing and retrieving data that has been processed using microshard data fragmentation.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure.

Currently, data protection is achieved using one of several methodologies and structures. For example, data can be made less accessible by placing it on a protected server behind a firewall. Data can be made less understandable, by obfuscating it through methods like encryption. Lastly, data can be made less valuable by replacing portions of the data with placeholders through a method called “tokenization”. Each of these methods has limitations, particularly when used in isolation. Firewalls can be breached, or an “inside threat” can effectively bypass access controls. Token repositories are high-value targets that can be hacked or otherwise compromised.

The most common method for data security, both at rest and in motion (i.e., as it traverses a network or components of a computer system), involves obfuscation through encryption whereby data is scrambled using a “key”. Methods to decrypt this data, once acquired by an actor without the key, vary based on the complexity of the algorithm used. In all cases, it is presumed that the actor has the full set of encrypted data, making access to a decrypted copy a function of time and the amount of computational capability employed. The ease of decryption increases with the increase in a computer's processing speed. There is generally no expectation that computer speed will do anything but continue to increase thereby merely slowing down but not preventing the attacker from accessing the data.

More recently, data fragmentation has emerged as a technique to either obscure data though continuous relocation, or through allowing multiple encryption algorithms to be used within a file. New techniques can now focus on obscuring the data by creating microshard data fragments or microshard data that are smaller than the valuable data that is to be protected. Further, intentionally disordering them will frustrate attempts to find and reassemble the data.

Many data fragmentation processes rely on three key elements to provide security against an attacker gaining access to the source data after it has been fragmented. The attacker must recognize that the source data has been fragmented and has been stored in multiple locations. The attacker must also gain access to the location information for the fragmented information. This information is typically contained in a file, referred to as a pointer file. The pointer file generally allows an attacker to reassemble the source data from the fragmented data once it is retrieved from storage. The attacker must further find the access information for the storage resources containing the fragmented data. The access information is typically contained in a file, referred to as a hostmap, or hostmap file. The hostmap file includes the credentials needed for accessing the storage resources as well as any mapping information if tokenization has been applied to the pointer file. If the attacker is missing any one of these three elements, the attacker will not be able to successfully merge or reassemble the fragmented data into the source data.

Typically, the pointer file and the hostmap are stored in memory by the provider of the data fragmentation service and may also be encrypted to increase the security level. Nonetheless, an attacker need only to find a security weakness with the provider of the data fragmentation service in order to potentially gain access to both the pointer file and the hostmap file. Therefore, there is a need for a further separation of the duties and responsibilities of ownership and security with respect to the elements of data fragmentation process.

### SUMMARY

According to one implementation, a method is described. The method includes receiving a request from an owner of a source file to break the source file into a set of microshard data fragments and store the set of microshard data fragments, processing the source file to generate the set of microshard data fragments representing the source file and store the generated set of microshard data fragments in a plurality of storage resources, generating authentication information linking the owner of the source file to the stored set of microshard data fragments, generating a pointer file identifying the locations on the storage resources where each microshard data fragment from the set of microshard data fragments is stored, and providing the pointer file to the owner of the source file without retaining a copy of the pointer file. At least a portion of the authentication information is also provided to the owner of the source file allowing the owner to request future access to the generated set of microshard data fragments.

According to another implementation, an apparatus is described. The apparatus includes a communication interface that receives a request from an owner of a source file to break the source file into a set of microshard data fragments and store the set of microshard fragments, and a processor coupled to the communication interface, the processor configured to process the source file to generate the set of microshard data fragments representing the source file and store the generated set of microshard data fragments in a plurality of storage resources, the processor further configured to access information linking the owner of the source file to the stored set of microshard data fragments and generate a pointer file identifying the locations on the storage resources where each microshard data fragment from the set of microshard data fragments is stored. The pointer file is provided to the owner of the source file without retaining a copy of the pointer file along with authentication information allowing the owner to request future access to the generated set of microshard data fragments.

According to another implementation, a system is described. The system includes a plurality of storage resources, each of the storage resources storing a portion of a set of microshard shard data fragments representing a source file. The system also includes a customer service device that receives access information from an owner of the source file, the pointer file linking storage locations to the set of microshard data fragments representing the source file, the customer service device authenticating the access to the microshard data fragments by the owner. The system further includes a merge service device that is coupled to the authentication service device, the shard merge service device receiving a pointer file from the owner and retrieving the set of microshard data fragments from the plurality of storage resources based on information in the pointer file, the merge service device further processing the set of microshard data fragments to reconstruct the source file and providing the reconstructed source file to the owner without retaining a copy of the pointer file.

### BRIEF DESCRIPTION OF THE DRAWINGS

The above and other aspects, features, and advantages of the present disclosure will become more apparent in light of the following detailed description when taken in conjunction with the accompanying drawings to which the principles of the present disclosure are applicable:

FIG. 1 is a block diagram of an exemplary system, according to aspects of the present disclosure;

FIG. 2 is a block diagram of an exemplary processing device used in the system of FIG. 1, according to aspects of the present disclosure;

FIG. 3 is a table illustrating an exemplary pointer file associated with storage of microshard data fragments, according to aspects of the present disclosure;

FIG. 4 is a table illustrating a mapping file associated with storage of microshard data fragments, according to aspects of the present disclosure;

FIG. 5 is a table illustrating another exemplary pointer file associated with storage of microshard data fragments, according to aspects of the present disclosure;

FIG. 6 is a flow chart of an exemplary process for securing source data in a set of storage locations, according to aspects of the present disclosure;

FIG. 7 is a flow chart of another exemplary process for processing a hostmap file associated with securing source data in a set of storage locations, according to aspects of the present disclosure; and

FIG. 8 is a flow chart of a further exemplary process for retrieving secured source data stored as microshard data fragments from a set of storage locations, according to aspects of the present disclosure.

### DETAILED DESCRIPTION

It should be understood that the components shown in the figures may be implemented in various forms of hardware, software, or combinations on one or more appropriately programmed general-purpose devices, which may include a processor, memory, and input/output interfaces. Those skilled in the art will be able to devise various arrangements which, although not explicitly described or shown herein, embody the principles of the disclosure and are included within its scope.

All examples recited herein are intended to aid the reader in understanding the principles of the disclosure and the concepts and are to be construed as being without limitation to such specifically recited examples and conditions. Any flow charts, flow diagrams, state transition diagrams, pseudocode, and the like represent various processes which may be substantially represented in computer readable media and so executed by a computer or processor, whether or not such computer or processor is explicitly shown.

The functions of the various components shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, a system on a chip (SoC), digital signal processor (“DSP”) hardware, read only memory (“ROM”) for storing software, random access memory (“RAM”), and nonvolatile storage.

As used herein, the term “processor” broadly refers to and is not limited to a single-or multi-core general purpose processor, a special purpose processor, a processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), an SOC, and/or a state machine. As used herein, the terms “transaction” and “electronic transaction” broadly refer to any transaction which may be electronically validated by the recited system, method, and apparatus.

One or more of the aspects of the embodiments described above may be implemented using application-specific hardware. Further, one or more aspects of the embodiments may be implemented using one or more processing components, such as central processing units (CPUs) that may include specific operating instructions embedded as firmware in the processing component(s) or may operate from software code that is downloaded into the storage elements from one or more memory units coupled to the processing components(s). The present disclosure addresses issues related to preventing an attacker from gaining access to the key elements of data fragmentation processes, such as microshard data fragmentation. Most data fragmentation processes rely on three key elements to be able to securely store, retrieve, and reassemble the source data as well as prevent unwanted access to the source data after it has been fragmented. These elements are the fragmentation of the data and storage in multiple locations, the creation and use of a pointer file, and the creation and use of a storage access file, referred to as a hostmap file. If the attacker is able to ascertain or gain access to all of these three elements, the attacker will be able to successfully merge or reassemble the fragmented data into the source data. More importantly, gaining access to the pointer file and to the hostmap file may provide enough information about the fragmentation and storage element to allow an attacker to eventually gain access to the data. The pointer file and hostmap file are typically stored and maintained in equipment used by the data fragmentation service provider. That leaves the responsibility for security of these two elements in the hands of a single party, creating a potential vulnerability that can be exploited by the attacker.

Accordingly, the present disclosure creates a method, apparatus, and system that employs the concept of detached pointers. The detached pointers concept stretches, or enhances, the separation of duties for security between the party that owns the data and the microshard data fragmentation service provider. The concept further allows better control over the security of the data by the owner. This mechanism involves, among other things, creating an authentication mechanism between the owner of the data and the microshard data fragmentation service provider. Once the authentication mechanism is in place, the owner may request that a source file be processed using microshard data fragmentation with the microshard data fragments stored in multiple storage facilities and geographic locations. Authentication information is generated for the stored microshard data and a pointer file is generated that identifies the storage locations for the microshard data fragments. The pointer file, along with the necessary authentication information, is provided to the owner without the microshard data fragmentation service provider retaining a copy of the pointer file. The owner stores and maintains the pointer file at their facilities. Only the hostmap file remains with the microshard data fragmentation service provider. By stretching or enhancing the separation duties in this manner, an attacker needs to gain access to both the facilities of the microshard data fragmentation service provider as well as the facilities of the owner of the source data in order to gain access to the pointer file and the hostmap file.

In some cases, if tokenization of pointer values is used, the tokenized pointer values replace the original values in the pointer file and the hostmap file is updated with a mapping between original values and tokenized values. Additionally, the hostmap file may further be processed using microshard data fragmentation and a pointer file created for the microshard data fragments associated with the created pointer file. This pointer file for the microshard fragmented hostmap file may further be provided to the owner, further stretching or enhancing the separation of duties for security between the owner and microshard data fragmentation service provider.

The use of detached pointers in a system architecture that includes microshard data fragmentation services provides advantages to both enterprise customers as well as a group of smaller disparate customers. Enterprise customers that include separate departments can compartmentalize activities associated with the microshard data fragmentation services and activities associated with storing and managing the pointer files for the set of generated and stored microshard data fragments between the separate departments. For example, an enterprise customer can utilize a group of storage managers to manage dedicated in-house shard/merge services along with any company-provided storage resources used to hold the microshard data fragments. Individual teams or application units within the enterprise can separately manage the pointer files to their own source data. As a result, the individual teams or application units that own the source data are the only parties that can access and reassemble their sharded data into the original source files from those company-provided storage resources. Alternatively, a group of smaller disparate customers may share common resources that are accessible by a common microshard data fragment service provider. Instead of allowing the microshard data fragment service provider to have access to the stored microshard data fragments from all of the customers, some or all of the group of customers can implement a detached pointer mechanism to control and manage the pointer file in order to prevent other customers in the group as well as the microshard data fragment service provider from gaining access to their data.

Advantages of the present disclosure will become more apparent from the detailed description given hereinafter. However, it should be understood that the detailed description and specific examples, while indicating preferred embodiments of the present disclosure, are given by way of illustration only, since various changes and modifications within the scope of the present disclosure will become apparent to those skilled in the art from this detailed description.

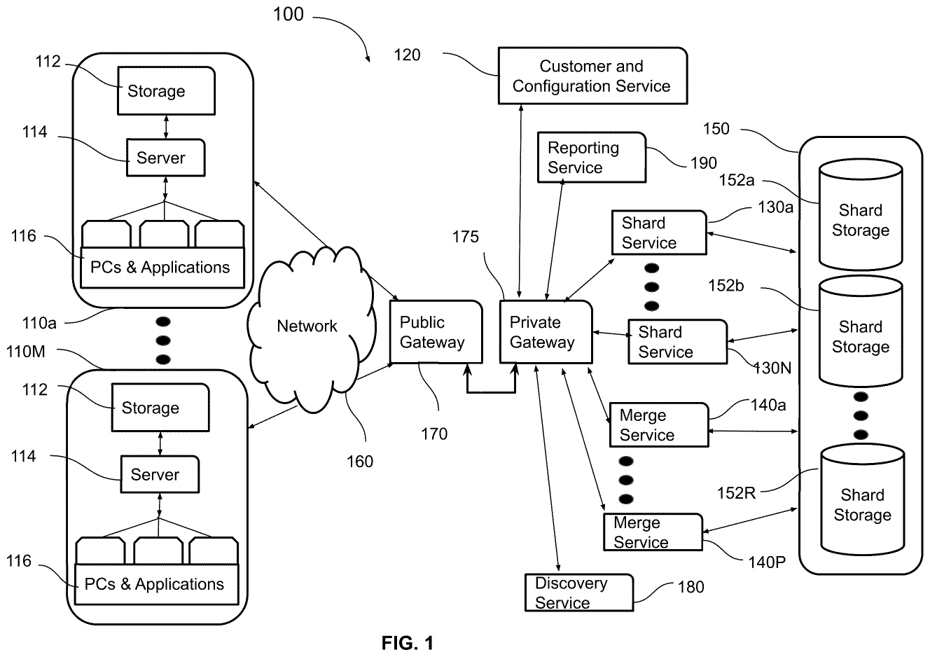

FIG. 1 illustrates a block diagram of an exemplary system 100 according to aspects of present disclosure. System 100 provides one possible arrangement that includes the operations and arrangements of a microshard data fragmentation and reassembly of source data that utilizes a detachable pointers concept in conjunction with the owner of the source data. In system 100, a set of facilities 110a-110M associated with customers that are using secure storage services are connected to a public gateway service 170 through a public network 160. Each of the customer facilities 110 includes a storage element 112, a server 114 and a set of personal computers (PCs) and application 116. The public gateway service 170 is further coupled to a private gateway service 175 as part of a microshard data fragmentation provider facility. The private gateway service 175 is coupled to a set of services available to the customer or user by the microshard data fragmentation service provider. These services include a customer and configuration service 120, a discovery service 180, and a reporting service 190. The private gateway service 175 is also coupled to a set of shard services 130a-130N and a set of merge services 140a-140P. Each of the shard services 130a-130N and each of the merge services 140a-140P are communicatively coupled to storage facilities 150. One or more of the storage facilities may be operated by the microshard data fragmentation service provider while other storage facilities may be operated by storage service providers. The storage facilities 150 include shard storage resources 152a-152R.

Customer facilities 110a-110M are operated by customers that are the owners of source data that may require secure storage of that source data. Other types of owners of the source data include, but are not limited to, users, content providers, data providers and the like. Each of the customer facilities may 110a-110M may be owned and operated by separate owners. In some embodiments, one or more of the users or customers may own and operate more than one of the customer facilities 110a-110M. Each of the customer facilities 110a-110M may include a server 114 that provides internal network access to a plurality of PCs and Applications 116. Server 114 also provides internal network access to storage resources 112. Further, server 114 may provide an interface for the customer facilities 110a-110M to external networks, including network 160. The storage resources 112 may include local storage resources for data in the customer facilities 110a-110M. The storage resources may also include dedicated storage resources associated with managing data that is stored external to the customer facilities 110a-110M.

The public gateway service 170 and private gateway service 175 provide a secure communication network interface between the network infrastructure operating the customer facilities 110a-110M through public network 160 and the private network infrastructure employed in the microshard data fragmentation service provider facility. In some embodiments, the public gateway service 170 and private gateway service 175 reside on and operate from separate physical devices that are communicably coupled together. With the use of separate physical devices, a high level of security may be maintained between the network infrastructures, such as preventing exposure of the private network infrastructure of the data sharding service provider facility within the public network 160. In other embodiments, using alternate security conditions and requirements, public gateway service 170 and private gateway service 175 may reside on and operate from the same physical device, such as a computer. The customer facilities 110a-110M may communicate with the public gateway 170 using a secure internet protocol. In some embodiments, the protocol may be the simple storage service (S3) protocol often used in conjunction with the use of storage services. In some embodiments, the protocol may be a native protocol based on the S3 protocol and/or one or more other protocols and customized for low latency or other high performance requirements. Other protocols that may be used include, but are not limited to, secure sockets layer (SSL) protocol, transport layer security (TLS) protocol and the like. The communication between public gateway service 170 and private gateway service 175 may similarly use a secure protocol or may be air gapped from any other network infrastructures.

The private gateway service 175 receives the secure requests associated with processing source data for secure storage from an owner, such as a user or a customer, originating at one of the customer facilities 110a-110M and passed through the public gateway service 170. These requests may include, but are not limited to, requests for breaking the source file into a set of microshard data fragments, storing the set of microshard data fragments in secure external storage, retrieving the stored microshard data fragments, reassembling the microshard data fragments into the source data, and returning the source data to the owner. In this manner, the combination of the public gateway service 170 and private gateway service 175 may be considered an authentication service for these requests based on the use of a secure protocol as described above.

The customer and configuration service 120 provides an interface and information repository for customers or users that utilize external secure storage services and the external storage services, such as the shard services 130a-130N and the merge services 140a-140P. The customer and configuration service 120 receives the requests for establishing a new customer and communicating with the new customer to establish any necessary authentication information associated with using the provided services. The customer and configuration service may also confirm and/or provide authentication information specific to a customer as part of verification to use a service based on a request from the customer. In this manner, the customer and configuration service 120 may be considered part of an authentication service. The customer and configuration service 120 also stores other information associated with customers and related to the processing, storage, and retrieval of data for the customers. The customer and configuration service 120 may operate on a separate processing device or may operate in conjunction with other services as part of a multi-operation or multi-service processing device. The processing device may include components, such as processors, memories, network interfaces, user interfaces, and the like.

The shard services 130a-130N provide data fragmentation of source data into microshard data fragments. The shard services 130a-130N further provides an interface for securely storing the microshard data fragments in one or more of the storage facilities 150. Each of the shard services 130a-130N may operate as a separate processing element on different processing devices. In some embodiments, more than one of the services 130a-130N may operate on the same processing device. Further, the shard services 130a-130N may operate in conjunction with other services on the same or different processing devices as described above. In some embodiments, the shard services 130a-130N may be configured as a slim, fast start service that can use a container orchestration system, such as Kubernetes, to scale the size of the operation as needed.

The merge services 140a-140P provides merging or reassembly of microshard data fragments. The merge services 140a-140P further provides an interface for retrieving the microshard data fragments from one or more of the storage facilities 150. Each of the merge services 140a-140P may operate as a separate processing element on different processing devices. In some embodiments, more than one of the merge services 140a-140P may operate on the same processing device. Further, the merge services 140a-140P may operate in conjunction with other services, such as the shard services 130a-130N, on the same or different processing devices as described above. In some embodiments, may be configured as a slim, fast start service that can use a container orchestration system similar to that described above.

The customer and configuration service 120, shard services 130a-130N, and merge services 140a-140P form the core set of services provided at facilities operated by a microshard data fragmentation service provider. These core services may communicate with each other, along with discovery service 180 and reporting service 190 using a secure internet protocol similar to that described above.

Storage facilities 150 are commercial memory service operators that provide storage of data in the cloud. Each of the storage facilities 150 may be at various locations geographically separated from each other and from the other elements in system 100. The shard storage resources 152a-152R used by storage facilities 150 may be dedicated portions of the storage facilities 150 for securely storing microshard data fragments for customers utilizing the shard services 130a-130N and/or the merge services 140a-140P. Each shard storage resource 152a-152R contains a set of storage elements, used to store individual microshard data fragments. In some embodiments, each storage element can store a single microshard data fragment. In other embodiments, some or all of the storage elements may be able to store a plurality of microshard data fragments. Examples of devices that may be used for storage resources 152a-152R include, but are not limited to, magnetic disk drives, optical disk drives, solid state drives, and the like.

It is worth noting that, as shown in FIG. 1, each of the shard services 130a-130N and merge services 140a-140P are shown as directly communicating to storage facilities 150. Such an arrangement is exemplary only and does not indicate that the communication does not occur through a wide area network. For example, each of the shard services 130a-130N and merge services 140a-140P may communicate with the storage facilities 150 over network 160. Further, some or all of the communication between the shard services 130a-130N and merge services 140a-140P and the storage facilities 150, through any communication network may use a secure network protocol, such as one of the network protocols described above.

The discovery service 180 is configured to operate as a service coordinator between the customer and configuration service 120, shard services 130a-130N, and merge services 140a-140P. The discovery service 180 assists with coupling a request for a service (e.g., a shard service or a merge service) to a particular one or more of the shard services 130a-130 and/or merge services 140a-140P. The coupling may further be based on customer information from the customer and configuration service 120. As such, discovery service 180 handles the discovery and management of available services, including the starting and stopping of those services for the various customers based on those requests. The discovery service 180 may operate on a separate processing device or may operate in conjunction with other services as part of a multi-operation or multi-service processing device. The processing device may include components, such as processors, memories, network interfaces, user interfaces, and the like.

The reporting service 190 is configured to operate as a performance manager for the shard services 130a-130N and merge services 140a-140P. The reporting service 190 may gather data and metrics from the shard services 130a-130N and merge services 140a-140P for individual customers. The reporting service may further gather aggregated metrics used for statistical analysis, without identification of individual customers, in order to identify potential issues and/or assist with improvements to the services. The reporting service 190 may operate on a separate processing device or may operate in conjunction with other services as part of a multi-operation or multi-service processing device. The processing device may include components, such as processors, memories, network interfaces, user interfaces, and the like.

In some embodiments, more than one data sharding service facility may be available for use by one or more of the customer facilities 110a-110M. In some cases, multiple data sharding service facilities may cover multiple regions or locations. In these embodiments, the public gateway service 170 may also include, as part of or additionally, a discovery service. This discovery service may be configured to allow the customer facilities 110a-110M to identify a public gateway service 170 associated with a particular data sharding service facility, including a nearest available facility.

In one operation, a customer from one of the customer facilities 110a-110M, as the owner of a file containing source data, initiates communication through the public gateway service 170 over the network (e.g., public network 160). The communication includes a request for processing the source data using the shard services 130a-130N. The communication, if authenticated through the network protocol (e.g., S3 protocol), is passed to the private gateway 275 for a determination of where the communication should be routed. If it is determined, based on the request, that the customer is a new customer, the private gateway routes the communication to the customer and configuration service 120. The customer and configuration service 120 identifies the customer as a new customer and creates a unique authentication mechanism to allow the customer access through private gateway 175 to the other services provided by the microshard data fragmentation service provider. In some embodiments, the customer and configuration service 120 generates an access key pair (e.g., a master key and a unique key) to allow secure communication over an established secure communication protocol (e.g., the S3 protocol). The customer may further provide a secret to complete the authentication initialization process. The customer and configuration service 120 may store one of the access keys (e. g, the master key) and the secret as part of a customer specific hostmap file and further may provide the other access key (e. g, the unique key) to the customer over the network. In other embodiments, other authentication mechanisms may be used. The customer and configuration service 120 stores customer authentication information in a hostmap file that is unique to each customer.

Once the authentication mechanism is complete, the customer provides a communication including the source data over the network (e.g., public network 160) along with the authentication information (e.g., an access key and secret) to public gateway 170. Once the information is authenticated through the network protocol, the private gateway 175 routes the information to one of the shard services 130a-130N, in some cases with assistance from discovery service 180. The one of the shard services 130a-130N first verifies the authentication information for the customer against an internal cache. If the authentication information is not found and/or verified, the one of the shard services 130a-130N requests verification of the authentication information through the customer and configuration service 120. If the customer and configuration service 120 responds with verification of the authentication information, the authentication information is stored in an internal cache as part of the shard service 130a-130N to avoid further lookup for a period of time.

During the microsharding process in shard services 130a-130N, the source data is processed to generate a set of microshard data fragments. Each microshard data fragment from the generated set is assigned for storage in one or more of the shard storage resources 152a-152R at storage facilities 150 according to a policy established by one or both of the shard services (130a-130N) and the storage facilities 150. When the shard services 130a-130N have completed processing of the source data, a pointer file is generated for the stored microshard data fragments. Any access information and credentials associated with the storage facilities 150 is provided to customer and configuration service 120 and added to the hostmap file for the customer. The customer and configurations service 120 provides any updated authentication information (e. g, an additional or updated access key) to the customer back through private gateway service 175 and over public network 160. The shard services 130a-130N also provide the pointer file pointer back to the customer, either directly through private gateway service 175 or indirectly using the customer and configuration service 120. The shard services 130a-130N and/or the customer and configuration service 120 does not store the pointer file or any data that directly references where the microshard data fragments are stored.

In some embodiments, some or all of the data in the pointer file may be tokenized. For instance, a process of value substitution may be applied to the data in order to hide or obscure the actual values associated with the locations of the microshard data fragments in storage facilities 150. A mapping file may be generated as part of the shard services 130a-130N that maps the original values in the pointer file to the tokenized values that replace the original values in a tokenized pointer file. The tokenized pointer file replaces the original pointer file, which no longer exists. The mapping file may be added to the hostmap file in the customer and configuration service 120 for the customer.

In another operation, a customer from one of the customer facilities 110a-110M, as the owner of a file containing source data that has been previously processed using shard services 130a-130N, initiates a new communication including a request for use of one or more of the merge services 140a-140P over the network (e.g., network 160) to public gateway service 160 using the authentication mechanism and the communication protocol described above. The communication includes a request for reassembling the source data using the merge services 140a-134P. Once the information is authenticated through the network protocol, the private gateway 175 routes the information to one of the merge services 140a-140P, in some cases with assistance from discovery service 180. The one of the merge services 140a-140P first verifies the authentication information against an internal cache. If the authentication information is not found and/or verified, the one of the merge services 140a-140P requests verification of the authentication information through the customer and configuration service 120 as described above. Once customer authentication is verified, the customer provides the pointer file associated with the source data that has been previously processed and stored by the shard services 130a-130N to the merge services 140a-140P.

During the merging process, the merge services 140a-140P retrieve each of the microshard data fragments identified in the pointer file from the appropriate storage resources 152a-152R in storage facilities and reassembles the microshard data fragments into the source data using the values in the pointer file. The pointer file may be stored in an internal cache until completion of the service request. In some embodiments, if values in the pointer file file have been tokenized, the merge services 140a-140p further request data from all or a portion of the hostmap file stored in the customer and configuration service 120 in order to map the tokenized values in the provided pointer file back to the original values values generated as part of storing the microshard data fragments in the shard services 130a-130N. When the Merge Service 140a-140P has merged or reassembled the retrieved microshard data fragments back into the source data, the source data is provided to the customer. As described above, the merge services 140a-140P do not store the pointer file or any data that references where the microshard data fragments are stored.

In some embodiments, updates may be made to the hostmap file, either as part of requests or other information provided by a customer, or based on security policy updates in the customer and configuration service 120. When an update to the hostmap file has occurred, a notification from the customer and configuration service 120 may be sent to the shard services 130a-130N and merge services 140a-140P. Alternatively, a polling mechanism may be included in the shard services 130a-130N and merge services 140a-140P and run periodically with the customer and configuration service 120. The shard services 130a-130N and merge services 140a-140N may update their internal hostmap file caches by requesting the updated hostmap file from the customer and configuration service 120.

In some embodiments, the shard storage resources 152a-152R at storage locations 150 used for some or all of the microshard data fragments for one or more customers may be changed. The change may be due to addition of, deletion of, or modification to the microshard data fragments or the source data used to generate the microshard data fragments. Additionally, in some embodiments the change may be due to security or unintended access concerns. In some cases, such as a change to the source data, the change is initiated as a request by the customer. Following verification of the customer's authentication information, the merge services 140a-140N may retrieve the set of microshard data fragments associated with the original source data and reassemble into the original source data using the pointer file provided by the customer as described above. The customer and configuration service 120 may modify the original source data based on information in the request from the customer and provide the modified source data to the shard services 130a-130N for processing to generate a new set of microshard data fragments. The shard services 130a-130N stores the new set of microshard data fragments in available shard storage resources 152a-152R at storage locations 150 and provides the pointer file to the customer as described earlier. In other cases, such as changes to locations of one or more microshard data fragments in the shard storage resources 152a-152R, the shard services 130a-130N may generate a new pointer file and provide the new pointer file to the customer as described above.

In some embodiments, the customer may use a pointer storage service from the microshard data fragmentation service provider. The pointer store service provides storage and management for the information in the pointer file and may be deployed as a storage cluster, as part of the storage 112, at the customer facility (110a-110M). The pointer storage service may be initiated by the customer, either directly or indirectly through the customer and configuration service 120 over a secure network protocol as described above. Once verification of the customer's authentication is complete, the merge services (130a-130N) may accept requests from the pointer store service. deployed at the customer facility 110a-110M. The pointer store service may further be configured before start-up with the customer authentication information and uniform resource locators (URLs) to the shard and merge services. In one embodiment, a database manager, such as Apache Ignite® is used as a replicated, distributed memory database to store the information in the pointer file.

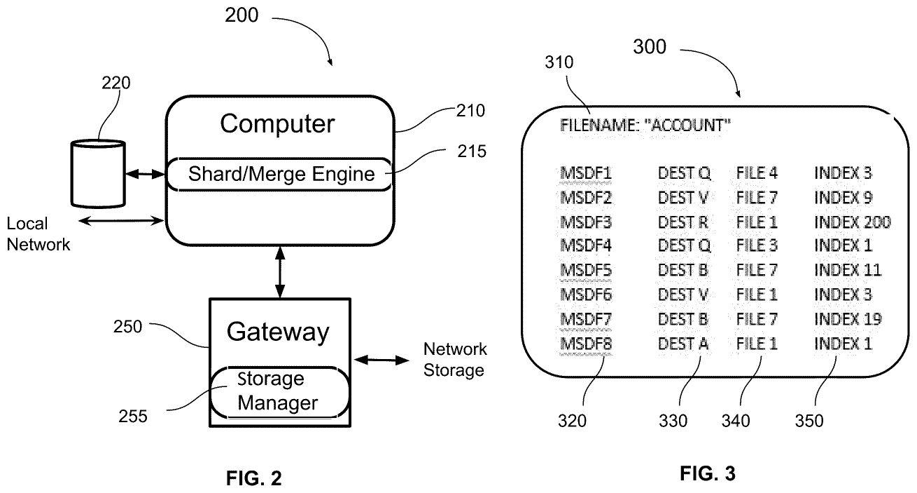

FIG. 2 illustrates a block diagram of an exemplary processing device 200 according to aspects of the present disclosure. Processing device 200 may be used for one or more shard and/or merge services, such as shard services 130a-130N and/or merge services 140a-140P described in FIG. 1. Processing device 200 includes a computer 210. Computer 210 is coupled to memory 220. Computer system 210 further includes a shard/merge engine 215. Computer 210 is also coupled to gateway 250. Gateway 250 provides the interface to network 260 in order to send and receive sharded data fragments to and from shard storage facilities, such as storage facilities 150 in FIG. 1. Gateway 250 further includes a storage manager 255.

Computer 210 includes various components for interfacing to networks, processing data, and communicating with a user or operator through various interface components such as, but not limited to, a network communication interface, a keyboard, a video display, and the like. Computer 110 may also include various forms of local memory including, but not limited to, ROM, RAM, nonvolatile memory, and the like. More specifically, computer 210 includes a shard/merge engine 215. Shard/merge engine 215 may include one or more processors configured to perform the operations associated with one or both of the microshard data fragmentation and reassembly of source data from a file as part of the shard services 130a-130N and merge services 140a-140P described in FIG. 1. For example, computer 210 may receive data, including source data, directly from a customer over a network (e.g., public network 160) through a secure gateway service (e.g., public gateway service 170 and private gateway service 175 using a secure protocol) or indirectly from another service from the service provider (e.g., customer and configuration service 120). Computer 210 may process the data and provide some of the processed data to back to the customer service and/or provide some of the processed data, in the form of microshard data fragments, to gateway 250. In some embodiments, the microshard data fragments may have a maximum size that is less than the size of a data field for the source data in the file. Computer 210 may also receive sharded data from one or more storage facilities, such as storage facility 150, through gateway 250 over network 260. Computer 210 may also receive data, including microshard data fragments, from gateway 250. Computer 210 may process the data, and provide some of the processed data back to the gateway 250 and/or provide some of the processed data, including source data recovered from the microshard data fragments, to the customer service. Computer 210 may be configured to operate as, and implement, one or both of the shard or merge services. Computer 210 may also be configured to operate in conjunction with other computers (not shown) to operate as, and implement these or similar services. Examples of devices that can be used for computer 110 include, but are not limited to, a desktop computer, a laptop computer, a tablet, a mobile phone, a computer server, and the like.

Memory 220 stores instructions and control software used by computer 210 as part of processing data, such as source data and microshard data fragments. Memory 220 may also store received data, either from the customer service or the gateway 250, for later processing, and also store processed data as needed and/or prior to delivery to other devices, such as storage facilities, through network 260. Examples of devices that may be used for memory 220 include, but are not limited to, a magnetic disk drive, an optical disk drive, a Gateway 250 provides a network interface to communicate with storage facilities located geographically a great distance from either computer 210 or gateway 250, such as storage facility 150 in FIG. 1 Gateway 250 may also include one or more services associated with storage, management, and retrieval of data in relation to the storage facilities. These services may include, but are not limited to, object storage services database management services, disk storage management services, process manager services, and the like. For example, gateway 250 may provide microshard data fragments generated by computer 210 to any or all of shard storage resources 152a-152P. Gateway 250 includes a storage manager 255 that manages delivery and storage, as well as the retrieval, of the microshard data fragments at the storage facilities. Storage manager 255 may identify the microshard data fragments associated with the source data processed in the computer 210 and generate routing information for delivering and storing the microshard data fragments in storage resources at the storage facilities, such as shard storage resources 152a-152R, over a communication network. The storage manager 255 may also manage the destination information to track any of the microshard data fragments that are stored in the described storage resources. For example, storage manager 255 may create and manage a set of pointers to each of the microshard data fragments and use the pointers to identify memory locations or storage elements in each of the storage devices or structures where the microshard data fragments are stored. The storage manager 255 may retrieve microshard data fragments from the memory locations or storage elements from any of the storage facilities through the communication network and provide the microshard data fragments to computer 210 for reassembly into source data as described above. Examples of devices that may be used as gateway 150 include, but are not limited to, a server hub, a modem, a desktop computer, a laptop computer, and the like. Further information about the generation of microshard data fragments and pointers from a source file, along with the reassembly of the source from the microshard data fragments using a process device similar to processing device 200 is described in US20200143074A1.

It is worth noting that, in some embodiments, computer 210 may be configured to include some or all of the operations of storage manager 255 in order to operate cooperatively with, or in place of the storage manager 255 in gateway 250. Further, gateway 250 may also be configured to include some or all of the operations of shard/merge engine 215 in order to operate cooperatively with, or in place of the shard/merge engine 215 in computer 210 Additionally, in some embodiments, gateway 250 and computer 210 may be combined into a single device operating as processing device 200. It is also worth noting that the use of a plurality of memory storage devices (e.g., shard storage 152a-152P) in various storage facilities (e.g., storage facility 150) at various locations may limit the ability of an attacker to eavesdrop on a network segment and capture microshard data fragments as they are written or read.

As part of a request to operate as a shard service (e.g., shard services 130a-130N) at processing device 200, source data received from a customer or user, in a manner similar to that described above, is provided to shard/merge engine 215 for processing. The shard/merge engine 215 is configured to split the provided data, or source data, into a plurality of microshard data fragments, with each microshard data fragment containing only a portion of any one data element of the source data. The microshard data fragments are provided to gateway 250 for delivery to storage facilities (e.g., storage facilities 150). Storage manager 255 further generates a pointer file identifying the locations where each of the set of microshard data fragments are stored. The processing device 200 provides the only copy of the pointer file back to the customer or user either directly or through the customer service. The processing device 200 does not retain any copy of the generated pointer file.

As part of a request for operation as a merge service at processing device 200, a pointer file received from a user or customer, in a manner similar to that described above, is provided to shard/merge engine 215 for processing. The pointer file identifies the locations of a set of microshard data fragments that represent data in a source file owned by the user or customer. The shard/merge engine is configured to retrieve the set of microshard data fragments from storage facilities (e.g., storage facilities 150) through storage manager 255 and reassemble the set of microshard data fragments provided back into the original source data based on the identifiers in the pointer file. The processing device provides the reassembled file containing the original source data to the customer or user directly, or through the customer service. The processing device 200 does not retain any copy of the generated pointer file.

In some embodiments, authentication information linking the owner or customer to the source data may be verified in processing device 200. The authentication information may initially be generated as part of registering a new customer for a provided service (e.g., shard services 130a-130N, merge services 140a-140P in FIG. 1) by a customer service (e.g., customer and configuration service 120). In some embodiments, all or part of the customer service may be incorporated as part of processing device 200.

In some embodiments, the hostmap file used to maintain customer specific information and authentication, as described above in FIG. 1, may be further processed by the shard/merge engine 215. The hostmap file may be processed to generate a set of microshard data fragments representing the host map file. The set of microshard data fragments are stored using storage manager 255 in a manner similar to that described above. A pointer file associated with the hostmap file may be generated and provided to the customer or user with the hostmap file. The processing device 200 does not retain a copy of the pointer file associated with the hostmap file. The hostmap file may be reassembled in a manner similar to that described above. It is worth noting that the hostmap file is reassembled prior to verification of authentication information provided by user or customer as part of a request for a service.

FIG. 3 is a table illustrating an exemplary pointer file 300 according to aspects of the present disclosure. Pointer file 300 is associated with source data that has been converted into microshard data fragments and stored in a manner similar to that described above in FIGS. 1 and 2. The pointer file 300 includes a filename 310, identified as “ACCOUNT”. The filename 310 may be selected by the owner of the source data associated with the set of microshard data fragments (e.g., a user or customer) and may be the name of the file containing the source data. The filename 310 may alternatively be auto-generated as part of the generation of the pointer file for the set of microshard data fragments by a shard service as described above. The filename 310 may be stored as part of the hostmap file for the customer and further used for identification and/or verification as part of a merge service as described above. The pointer file 300 further includes information for the set of microshard data fragments generated from the source data. As shown in FIG. 3, eight microshard data fragments have been generated and are included in the pointer repository file 300. In other embodiments, more or fewer microshard data fragments may be included.

The pointer file 300 includes a first column 320 containing identifiers for each of the microshard data fragments. The identifiers are shown as “MSDF1” to “MSDF 8”. The microshard data fragment identifiers may be created automatically as the microshard data fragments are generated in the shard service (e.g., shard services 130a-130N in FIG. 1). However, the identifiers may not be in any type of numerical order as long as the identifier for each microshard data fragment in the pointer file 300 is unique. In some embodiments, a separate column (not shown) may include an ordering pattern for the identifiers in column 320. The pointer file 300 also includes a second column 330 containing identifiers for the location of the storage facility (e.g., storage facility 150) where the corresponding microshard data fragments identified in column 320, As described above, the set of microshard data fragments are typically stored at a plurality of different storage facilities as part of the security policy for the merge service.

The pointer file 300 additionally includes a third column 340 containing a file or path identifier corresponding to the identified storage facility in column 330. The information in column 340 typically provides a network communication path to, or filename in a system file structure on, a physical memory device at the storage facility, such as a hard disk drive or solid state memory device. In some embodiments, the information in column 340 may additionally or alternatively include an object tag that may be used to identify a particular memory location (e.g., a bucket) for the path or file and/or a key for unlocking the memory location. Although column 340 is shown as having an alphanumeric entry (“FILE 4”, “FILE 7”, etc.), the file or path identifier may be a computer network address, a uniform resource locator (URL) or similar identifier. The pointer file 300 further includes a fourth column 350 identifying an index or offset into the corresponding file or path identified in column 340. The information in column 350 typically provides a location on the physical memory device at the storage facility where the microshard data fragment is stored.

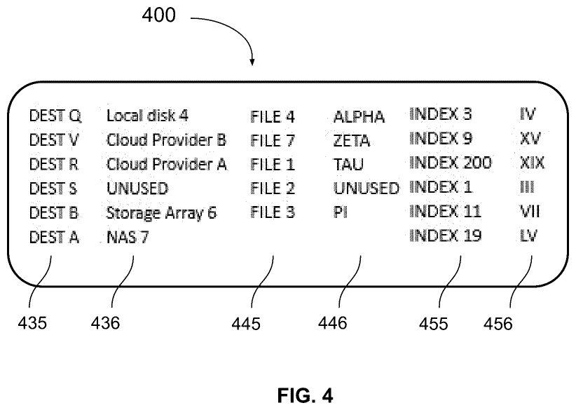

FIG. 4 is a table illustrating an exemplary mapping file 400 associated with a pointer file, according to aspects of the present disclosure. Mapping file 400 is associated with pointer file 300 described in FIG. 3. As described above, in some embodiments, some or all of the data in a pointer file, such as pointer file 300, may be tokenized for increased security and protection against attackers trying to access the microshard data fragments representing a source file. When any data in a pointer file is tokenized, the hostmap file provides a mapping between the tokenized data and the original identifiers in the pointer file. The mapping file 400 is included, along with authentication information for a customer, in a host map file. The host map file is stored and maintained at the facilities of the microshard data fragmentation service provider (e.g., as part of the customer and configuration service 120) as described in FIG. 1. In mapping file 400, column 435 contains the identifiers for the location of the storage facility, column 445 contains the file or path identifier, and column 455 contains the index or offset into the corresponding file or path from pointer file 300 that are to be replaced with tokenized values. In other embodiments, more or fewer columns in the pointer file 300 may be tokenized. Further, portions of a column may be tokenized while the remaining portion may not be tokenized. The mapping file 400 may be generated as part of the generation of the microshard data fragments by a shard service (e.g., in storage manager 255 in FIG. 2) following the generation of pointer file 300. The mapping file 400 can be used in conjunction with generating a new pointer file that replaces the original identifiers in a pointer file (e.g., pointer file 300) with tokenized values in order to increase security and preventer attackers from gaining access to the source data, as described above. The mapping file 400 may further be retrieved and used as part of the retrieval and reassembly of the set of microshard data fragments by a merge service. It is worth noting that any data that is not being tokenized is not included in the mapping file 400, in this case the identifiers for each of the microshard data fragments from column 320 in pointer file 300.

Hostmap file 430 includes a first column 435 containing the set of different storage locations identified in column 330 in FIG. 3. Column 435 includes fewer than eight rows, because only five different storage locations were used for the eight different microshard data fragments identified in column 320. A second column 436 contains the tokenized values for the corresponding storage location identifiers in column 435. As shown, an additional entry in column 435, labeled “DEST S”, is indicated as “UNUSED” in column 435. Similarly, a third column 440 and fourth column 445 contain the different file or path identifiers and corresponding tokenized values, and a fifth column 450 and sixth column 455 contain the different index or offset values and corresponding tokenized value. As shown, the tokenized values in each of the columns 435, 445, and 455 are similar in nature, or type, of identifier or value (e.g., alternate location identifiers, greek letters, roman numerals). In other embodiments, the tokenized values in the columns may be entirely random and further unrelated.

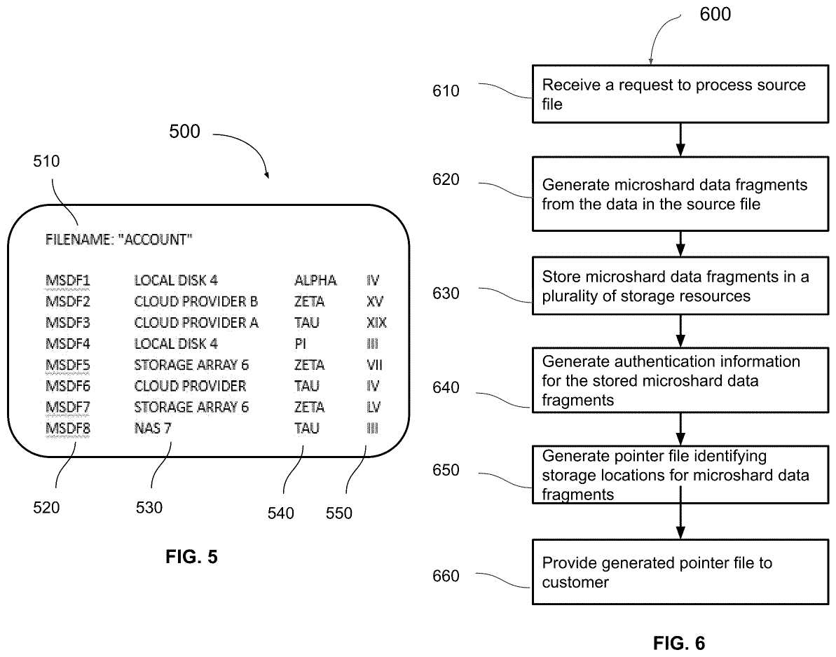

FIG. 5 is a table illustrating an exemplary pointer file 500 according to aspects of the present disclosure. Pointer file 500 is associated with source data that has been converted into a set of microshard data fragments and stored in a manner similar to that described above for pointer file 300 in FIG. 3. However, pointer file 500 includes token values in place of identifiers originally included in columns 340, 340, and 350 as part of pointer file 300. The replacement of the original values by the token values may be accomplished based on the mapping provided in mapping file 400 described in FIG. 4. The pointer file 500, containing token values, may be generated as part of the generation of the microshard data fragments by a shard service (e.g., in storage manager 255 in FIG. 2) following the generation of pointer file 300. It is worth noting once pointer file 500 is generated, pointer file 300 is erased and no longer exists. As a result, a mapping file (e.g., mapping file 400) must be available and included in the process of retrieving microshard data fragments from storage facilities (e.g., storage facilities 150 in FIG. 1) using a pointer file that includes token values (e.g., token file 500) as part of a merge service (e.g., merge service 140a-140P).

The tokenized pointer file 500 includes a filename 510, the same as in FIG. 3. Token repository file 500 further includes a first column, 520 containing the same microshard data fragment identifiers as in column 320 in FIG. 3, as these identifiers were not tokenized. A second column 530 contains the token values for each of the storage location identifiers originally in column 330. Similarly, columns 540 and 555 contain the token values for each of the file or path identifiers in column 340 and index or offset values in column 350, respectively. In some embodiments, the amount of data used by the tokenized values in token repository file 500 may be different from the amount data used by the original identifiers in pointer repository file 300. For example, while column 340 may include a long filename or network path being several bytes of data, the tokenized values in column 545 may be “short” values, containing only the number of bits needed to cover the number of unique filenames or network paths present in column 340.

It is worth noting that, as described above, the hosting map 400 may be included as part of the hostmap file created for each customer and stored as part of the customer service (e.g., customer and configuration service 120 in FIG. 1). Further, pointer file 500 containing token values in place of identifiers originally included in pointer file 300, is provided to the user or customer in place of pointer file 300 as part of the shard service (e.g., shard services 130a-130N).

FIG. 6 illustrates a flow chart of an exemplary process 600 for securing source data in a set of storage locations according to aspects of the present disclosure. Process 600 will be primarily described with respect to system 100 described in FIG. 1. One or more of the steps of process 600 may equally be applied to the processing device 200 described in FIG. 2. Further, one or more aspects of process 600 may be carried out by any service provider that provides data sharding or similar services through one or more facilities in a manner similar to that described above. Although process 600 depicts steps performed in a particular order for purposes of illustration and discussion, one or more of the operations discussed herein are not limited to any particular order or arrangement.

At step 610, a request is received from an owner of a source file to break the source file into a set of microshard data fragments and store the set of microshard fragments in secure remote storage. The owner may be a user, a customer, or a content or data provider. The request is provided over the network (e.g., public network 160 through. In some embodiments, if the customer is a previous customer, the customer may provide authentication information established when the customer previously requested a service, such as an access key and secret. The appropriate service (e.g., the private gateway service 175, customer and configuration service, and/or the shard services 130a-130N) compares and verifies the provided authentication information using information in a hostmap file established for the customer. In some embodiments, if the customer is a new customer, the customer service generates an authentication mechanism to allow the customer access to the service used to generate microshard data fragments and generates the hostmap file for the customer, in a manner similar to that described above. Further, as part of step 610, after initial authentication and access information and/or verification is established, the source file is provided by the owner.

At step 620, the source file provided by the owner, at step 610, is processed to generate a set of microshard data fragments that represent the data in the source file. The source file may be provided by the owner to a shard service (e.g., shard services 130a-130N) for processing in a manner similar to that described above. The shard service may be included as part of a shard/merge processing element, such as shard/merge engine 215 described in FIG. 2. In some embodiments, each of the microshard data fragments has a maximum size that is less than a predetermined size, such as the size of a data field in the source file.

At step 630, the set of microshard data fragments, generated at step 620, are stored. The generated set of microshard data fragments may be stored in one or more storage facilities (e.g., storage facilities 150) as described above. The storing of the set of microshard data fragments may be controlled by the shard service (e.g., shard services 130a-130N). For example, a storage manager (e.g., storage manager 255 in FIG. 2) may manage the delivery of each of the microshard data fragments to the storage resources (e.g. shard storage resources 152a-152P) in the storage facilities.

At step 640, authentication information associated with the microshard data fragments, stored at step 630, is generated The authentication information may include, among other things, access information associated with the storage facility. In some embodiments, all or a portion of the authentication information is stored as part of the hostmap file as described above.

At step 650, a pointer file identifying the locations of the storage resources where each microshard data fragment from the set of microshard data fragments, stored at step 630, is generated. The pointer file provides a link between storage locations and the set of microshard data fragments representing the source file. The pointer file may be generated as part of the shard service (e.g., shard services 130a-130N) and/or as part of another service from the service provider (e.g., customer and configuration service 120 or private gateway service 175). The pointer file may be generated using information provided from each of the storage facilities (e.g., storage facilities 150). Alternatively, the pointer file may be generated by a storage manager (e.g., storage manager 255 in FIG. 2) and storage instructions based on the pointer file provided to each of the storage facilities. The information, such as data and/or identifiers, in the pointer file may be arranged in a manner similar to pointer file 300 described in FIG. 3. In some embodiments, the values in the pointer file may include at least one of an identifier for the provider of the storage facility, an electronic address for the storage resource at the storage facility, and an electronic address for the memory location on the storage resource. In some embodiments, some or all of the information in the pointer file may be tokenized as described above.

At step 660, the pointer file generated, at step 650, is provided to the customer, as the owner of the source file. Further, as part of step 660 any other copy or version of the pointer file is erased or destroyed. In this manner, a copy of the pointer file is not retained within the customer configuration service (e.g., customer and configuration service 120), the shard services (e.g., shard services 130a-130N, or the storage facilities (e.g., storage facilities 150). In some embodiments, the pointer file is stored at a site or facility under the control of the owner (e.g., customer facilities 110a-110M). The pointer file may be stored in a data storage resource (e.g., storage 112) and may be stored and maintained using a pointer storage service, similar to that described above. Also, at step 660, all or a portion of the authentication information generated, at step 640, is provided to the owner in order to allow the owner to request future access to the generated set of microshard data fragments. In some embodiments, the owner may request future access as part of a request to retrieve and reassemble the source file from the microshard data fragments by providing the authentication information for verification along with the pointer file.

It is worth noting that one or more of the steps of process 600 may be modified, and steps may be added or omitted depending on a specific embodiment. In some embodiments that utilize tokenization of some or all of the information in the pointer file, step 650 may be modified to further include generating a token mapping file that maps the original values in the pointer file to the tokenized values that replace the original values in a tokenized pointer file. The token mapping file may be added to the hostmap file for the owner in the customer configuration service (e.g., customer and configuration service 120). Further, at step 660, the tokenized pointer file, which replaces the original pointer file, may be provided to the owner of the source file. Any other copy or version of the original pointer file or the tokenized pointer file is erased or destroyed as described above. Further, in some embodiments, the generating of authentication information, at step 640, may be eliminated or modified, depending on the type of authentication mechanism that is used.

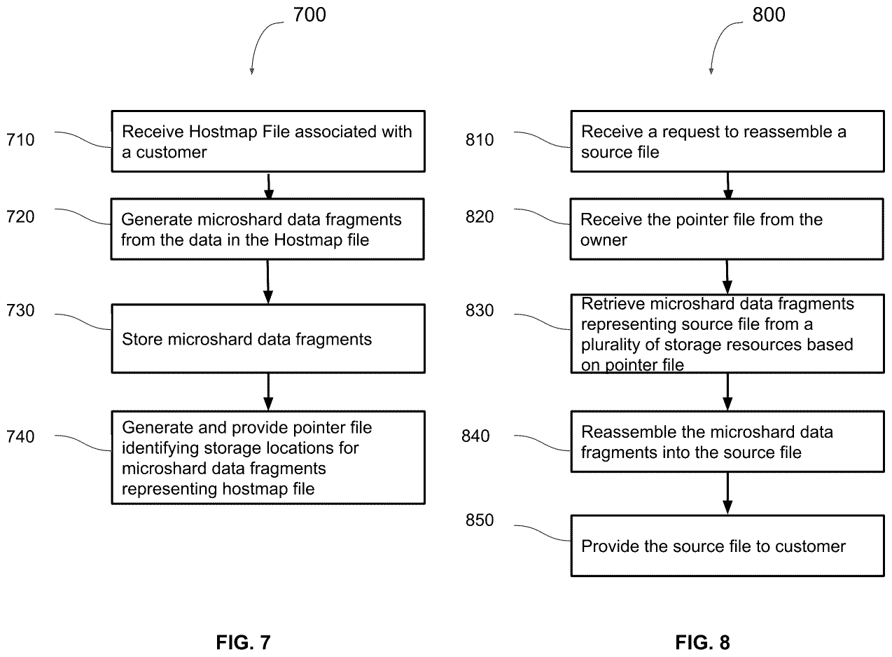

FIG. 7 illustrates a flow chart of another exemplary process 700 for processing a hostmap file associated with securing source data in a set of storage locations according to aspects of the present disclosure. Process 700 may be used in conjunction with process 600 described in FIG. 6. Process 700 will be primarily described with respect to system 100 described in FIG. 1. One or more of the steps of process 700 may equally be applied to the processing device 200 described in FIG. 2. Further, one or more aspects of process 700 may be carried out by any service provider that provides data sharding or similar services through one or more facilities in a manner similar to that described above. Although process 700 depicts steps performed in a particular order for purposes of illustration and discussion, one or more of the operations discussed herein are not limited to any particular order or arrangement.

At step 710, a hostmap file associated with a customer that uses microshard data fragmentation services is received for processing. The hostmap file is received by a shard service, such as one of the shard services 130a-130N described in FIG. 1, and provided by a customer service, such as customer and configuration service 120. In some embodiments, the hostmap file may be provided as a result of a request by the customer as the owner of a source file that has been processed by the shard service as described for process 600 in FIG. 6.

At step 720, The data in the hostmap file provided, at step 710, is processed to generate a set of microshard data fragments that represent the data in the hostmap file. The microshard data fragments are generated as part of a shard service (e.g., shard services 130a 130N) that may be included as part of a shard/merge processing element and operate in a manner similar to that described above.

At step 730, the set of microshard data fragments, generated at step 720, are stored. In some embodiments, the set of microshard data fragments may be stored in storage resources at one or more storage facilities (e.g., storage facilities 150 in FIG. 1) in a manner similar to that described above. In some embodiments, some or all of the set of data fragments may be stored in memory in a processing device as part of the customer service (e.g., customer and configuration service 120). The storing of the set of microshard data fragments may be controlled by the shard service through a storage manager in a manner similar to that described above.

At step 740, a pointer file identifying the locations of the storage resources where each microshard data fragment from the set of microshard data fragments associated with the hostmap file, stored at step 730, is generated. The pointer file may be generated as part of the shard service in a manner similar to that described above. The information, such as data and/or identifiers, in the pointer file may be arranged in a manner similar to pointer file 300 described in FIG. 3. In some embodiments, some or all of the information in the pointer file may be tokenized as described above. In some embodiments, the pointer file, generated at step 740, may be provided to the customer service (e. g, customer and configuration service 120 in FIG. 1) and stored separately from the hostmap file. The customer service may further create a local hostmap file containing authentication information similar to that described above for later access to the stored microshard fragments. In other embodiments, all or a portion of the pointer may be provided to the customer in order to further stretch or enhance the separation of duties for security between the owner and microshard data fragmentation service provider. In these embodiments, a copy of the pointer file may not be stored or otherwise retained by any of the services or devices used by the data fragmentation service provider.

It is worth noting that one or more of the steps of process 700 may be modified, and steps may be added or omitted depending on a specific embodiment. Further, the steps of process 700 may be carried out in conjunction with the steps of process 600 described in FIG. 6. As such, some or all of the steps of process 600 and some or all of the steps of process 700 may be combined to form a process for storing source data along with a hostmap file utilizing detachable pointers.

FIG. 8 illustrates a flow chart of a further exemplary process 800 for retrieving secured source data stored as microshard data fragments from a set of storage locations according to aspects of the present disclosure. Process 800 will be primarily described with respect to system 100 described in FIG. 1. One or more of the steps of process 800 may equally be applied to the processing device 200 described in FIG. 2. Further, one or more aspects of process 800 may be carried out by any service provider that provides data sharding or similar services through one or more facilities in a manner similar to that described above. Although process 800 depicts steps performed in a particular order for purposes of illustration and discussion, one or more of the operations discussed herein are not limited to any particular order or arrangement.

At step 810, a request is received from the owner of a source file associated with a set of stored microshard data fragments to reassemble a source file using stored microshard data fragments associated with the source file. The owner may be a user, a customer, or a content or data provider. The owner may also provide authentication information in order to validate access in a manner similar to that described above, such as an access key and a secret. Additionally at step 810, the owner provides the pointer file stored in a storage resource at the owner's facility by providing proper access information and the pointer file.

At step 820, the pointer file associated with the set of stored microshard data fragments is received from the owner. the pointer file linking storage locations to the set of microshard data fragments representing the source file The pointer file may be provided to one or more of the merge services (e.g., merge services 140a-140P) directly by the owner or indirectly through the customer service (e.g., customer and configuration service 120). The values in the pointer file may include at least one of an identifier for the provider of the storage facility, an electronic address for the storage resource at the storage facility, and an electronic address for the memory location on the storage resource. In some embodiments, some or all of the information in the pointer file may be tokenized as described above.

At step 830, the microshard data fragments are retrieved from the storage facilities (e.g., storage facilities 150) based on the pointer file received at step 820. The retrieval of the microshard data fragments may be controlled by the merge services (e.g., merge services 140a-140P). For example, a storage manager (e.g., storage manager 255 in FIG. 2) may manage the retrieval of each of the microshard data fragments from the storage resources (e.g. shard storage resources 152a-152P) in the storage facilities.

At step 840, the microshard data fragments retrieved, at step 830, are processed to reassemble or reconstruct the microshard data fragments into the source file. The processing is performed in one or more merge services (e.g., merge services 140a-140P). In some embodiments, the reassembly of the microshard data fragments uses the order of the fragment identifiers associated with the microshard data fragments that is in the pointer file.

At step 850, the source file, reassembled or reconstructed at step 840, is provided to the owner of the source file. The source file may be provided back to the owner in a manner similar to that described above. At step 850, in addition to the source, the pointer file provided by the owner, at step 720 is also provided back to the owner. Any other copy or version of the pointer file is erased or destroyed. In this manner, a copy of the pointer file is not retained within the customer configuration service, the shard service (e.g., shard services 130a-130N, or the storage facilities (e.g., storage facilities 150).

It is worth noting that one or more of the steps of process 800 may be modified, steps may be added or omitted depending on a specific embodiment. In some embodiments that utilize tokenization of some or all of the information in the pointer file, step 820 may be modified to further request the token mapping file stored in the host map file for the owner in the customer configuration service (e.g., customer and configuration service 120 in FIG. 1). The token mapping file received may be used to map the tokenized information in the pointer file received from the owner back to the original information in the pointer file generated as part of storing the microshard data fragments, as part of a process for securing source data in a set of storage locations, such as process 600 in FIG. 6. Further, in embodiments that include microshard data fragmentation of a hostmap file, step 820 may be modified to include receiving pointer files for the set of microshard data fragments representing the data in both the source file for the customer and the hostmap file. Further, in some embodiments, step 830 may be modified to first retrieve and reassemble the hostmap file using its pointer file before retrieving the set of microshard data fragments representing the source file. Further, the steps of process 800 are typically carried out after the steps of process 600 described in FIG. 6 have been completed. As such, some or all of the steps of process 600 and some or all of the steps of process 800 may be combined to form a process storing and retrieving source data utilizing detachable pointers.

It is to be appreciated that although the embodiments described above focus on physical hardware and components within a signal communication system, the principles of the present disclosure may be easily extended to implementations that involve software based programming instructions that are stored in a computer readable medium, such as a magnetic or optical based storage structure. Further, in some embodiments, one or more of the steps of a process based on the principles of the present disclosure, such as process 600, process 700 and/or process 800 described above may be implemented utilizing cloud-based operations and/or storage. It is to be appreciated that, except where explicitly indicated in the description above, the various features included as part of the principles of the present disclosure can be considered cumulative and interchangeable, that is, a feature shown in one embodiment may be incorporated into another embodiment.

Although embodiments which incorporate the teachings of the present disclosure have been shown and described in detail herein, those skilled in the art can readily devise many other varied embodiments that still incorporate these teachings. Having described preferred embodiments for utilization of detached pointers with microshard data fragmentation, it is noted that modifications and variations can be made by persons skilled in the art in light of the above teachings. It is therefore to be understood that changes may be made in the particular embodiments of the disclosure which are within the scope of the disclosure as outlined by the appended claims.

1. A method comprising:
receiving a request from an owner of a source file to break the source file into a set of microshard data fragments and store the set of microshard data fragments;
processing the source file to generate the set of microshard data fragments representing the source file and store the generated set of microshard data fragments in a plurality of storage resources;
generating authentication information linking the owner of the source file to the stored set of microshard data fragments;
generating a pointer file identifying the locations on the storage resources where each microshard data fragment from the set of microshard data fragments is stored; and
providing the pointer file to the owner of the source file without retaining a copy of the pointer file along with at least a portion of the authentication information allowing the owner to request future access to the generated set of microshard data fragments.

2. The method of claim 1, wherein the values in the pointer file include at least one of an electronic address for the storage resource, an electronic address for the memory location on the storage resource, and a provider of the storage resource.

3. The method of claim 1, further including:
tokenizing at least a portion of the values in the pointer file;
generating a mapping file identifying a relationship between the token values and the identified locations on the storage resources; and
storing the mapping file along with the authentication information in a host map file as part of an authentication service.

4. The method of claim 3, further comprising processing the host map file to generate a set of microshard data fragments representing the host map file and storing the generated set of microshard data fragments in a plurality of storage resources.

5. The method of claim 1, wherein the pointer file is stored at a site under the control of the owner.

6. The method of claim 1, wherein the portion of the authentication information includes at least one of an access key and a secret.

7. The method of claim 1, wherein each one of the set of microshard data fragments representing the source file has a maximum size that is less than the size of a data field in the source file.

8. The method of claim 1, wherein the owner is at least one of a user, a customer, and a provider.

9. The method of claim 1, wherein the owner can request retrieval and reassembly of the source file by providing proper access information and the pointer file.

10. An apparatus comprising:
a communication interface that receives a request from an owner of a source file to break the source file into a set of microshard data fragments and store the set of microshard fragments; and
a processor coupled to the communication interface, the processor configured to process the source file to generate the set of microshard data fragments representing the source file and store the generated set of microshard data fragments in a plurality of storage resources, the processor further configured to access information linking the owner of the source file to the stored set of microshard data fragments and generate a pointer file identifying the locations on the storage resources where each microshard data fragment from the set of microshard data fragments is stored;
wherein the pointer file is provided to the owner of the source file without retaining a copy of the pointer file along with authentication information allowing the owner to request future access to the generated set of microshard data fragments.

11. The apparatus of claim 10, wherein the values in the pointer file include at least one of an electronic address for the storage resource, an electronic address for the memory location on the storage resource, and a provider of the storage resource.

12. The apparatus of claim 10, wherein the processor is further configured to:
tokenize at least a portion of the values in the pointer file;
generate a mapping file identifying a relationship between the token values and the identified locations on the storage resources; and
provide the mapping file along with authentication information in a host map file as part of an authentication service.

13. The apparatus of claim 12, further comprising processing the host map file to generate a set of microshard data fragments representing the host map file and storing the generated set of microshard data fragments in a plurality of storage resources.

14. (canceled)

15. (canceled)

16. The apparatus of claim 10, wherein each one of the set of microshard data fragments that is generated from a source file has a maximum size that is less than the size of a data field in the source file.

17. (canceled)

18. The apparatus of claim 10, wherein the owner can request retrieval and reassembly of the source file by using the authentication information to provide the pointer file to the apparatus.

19. A system comprising:
a plurality of storage resources, each of the storage resources storing a portion of a set of microshard shard data fragments representing a source file;
a customer service device that receives access information from an owner of the source file, the pointer file linking storage locations to the set of microshard data fragments representing the source file, the authentication service device authenticating the access to the microshard data fragments by the owner; and
a merge service device that is coupled to the customer service device, the merge service device receiving a pointer file from the owner and retrieving the set of microshard data fragments from the plurality of storage resources based on information in the pointer file, the merge service device further processing the set of microshard data fragments to reconstruct the source file and providing the reconstructed source file to the owner without retaining a copy of the pointer file.

20. (canceled)

21. The system of claim 19, wherein the authentication information includes at least one of an access key and access information for the storage resources.

22. The system of claim 19, wherein each one of the set of microshard data fragments that is retrieved from the plurality of storage resources has a maximum size that is less than the size of a data field in the source file.

23. The system of claim 19, wherein the merge service is-further receives a mapping file from the authentication service, the mapping file providing a relationship between a set of token values in the pointer and a set of identifiers for the locations.

24. The system of claim 19, wherein the merge service further receives a different pointer file associated a set of microshard data fragments representing a hostmap file from the owner, retrieves set of microshard data fragments representing a hostmap file from the plurality of storage resources based on information in the different pointer file, set of microshard data fragments representing a hostmap file to reconstruct the hostmap file prior to receiving the pointer file from the owner.
